(19) United States
(12) Patent Application Publication
(10) Pub. No.: US 2009/0324199 A1
(43) Pub. Date: Dec. 31, 2009

(54) GENERATING FINGERPRINTS OF VIDEO SIGNALS

(75) Inventors: Jaap Andre Haitsma, Eindhoven (NL); Vikas Bhargava, San Diego, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,057

(22) PCT Filed: Jun. 14, 2007
(86) PCT No.: PCT/IB2007/052252

§ 371 Date: Dec. 16, 2008

(30) Foreign Application Priority Data
Jun. 20, 2006 (EP) 06115715.2

(51) Int. Cl. H04N 5/91

(52) U.S. Cl. 386/95; 386/E05.003

(57) ABSTRACT

The present invention provides novel techniques for generating more robust fingerprints (1) of video signals (2). Certain embodiments of the invention derive video fingerprints only from blocks (21) in a central portion (22) of each frame (20), ignoring a remaining outer portion (23), the resultant fingerprints (1) being more robust with respect to transformations comprising cropping or shifts. Other embodiments divide each frame (or a central portion of it) into non-rectangular blocks, such as pie-shaped or annular blocks, and generate fingerprints from these blocks. The shape of the blocks can be selected to provide robustness against particular transformations. Pie blocks provide robustness to scaling, and annular blocks provide robustness to rotations, for example. Other embodiments use blocks of different sizes, so that different portions of the frame may be given different weighting in the fingerprint.

### FIELD OF THE INVENTION

The present invention relates to the generation of fingerprints indicative of the contents of video signals comprising sequences of data frames.

### BACKGROUND OF THE INVENTION

A fingerprint of a video signal comprising a sequence of data frames is a piece of information indicative of the content of that signal. The fingerprint may, in certain circumstances, be regarded as a short summary of the video signal. Fingerprints in the present context may also be described as signatures or hashes. A known use for such fingerprints is to identify the contents of unknown video signals, by comparing their fingerprints with fingerprints stored in a database. For example, to identify the content of an unknown video signal, a fingerprint of the signal may be generated and then compared with fingerprints of known video objects (e.g. television programmes, films, adverts etc.). When a match is found, the identity of the content is thus determined. Clearly, it is also known to generate fingerprints of video signals having known content, and to store those fingerprints in a database.

It is desirable for the method of generating a fingerprint to be such that the resultant fingerprint is a robust indication of content, in the sense that the fingerprint can be used to correctly identify the content, even when the video signal is a processed, degraded, transformed, or otherwise derived version of another video signal having that content. An alternative way of expressing this robustness requirement is that the fingerprints of different versions (i.e. different video signals) of the same content should be sufficiently similar to enable identification of that common content to be made. For example, an original video signal, comprising a sequence of frames of pixel data, may contain a film. A fingerprint of that original video signal may be generated, and stored in a database along with metadata, such as the film's name. Copies (i.e. other versions) of the original video signal may then be made. Ideally, one would like a fingerprint generation method which, when used on any one of the copies, would yield a fingerprint sufficiently similar to that of the original for the content of the copy to be identifiable by consulting the database. However, a number of factors make this object more difficult to achieve. For example, in a copy of the original video signal, the global brightness and/or the contrast in one or more frames may have changed. Similarly, there may have been changes in color and/or image sharpness. In addition, the copy may be in a different format, and/or the image in one or more frames may have been scaled, shifted, or rotated. Also, different versions of video content may employ different frame rates. In an extreme case, the pixel data in a frame of one version of the film (e.g. a copy) may be completely different from the pixel data in a corresponding frame of another version (e.g. the original) of the same film. A problem is, therefore, to devise a fingerprint generation method that yields fingerprints that are robust (i.e. insensitive) to a certain degree to one or more of the above-mentioned factors.

WO02/065782 discloses a method of generating robust hashes (in effect, fingerprints) of information signals, including audio signals and image or video signals. In one disclosed embodiment, a hash for a video signal comprising a sequence of frames is extracted from 30 consecutive frames, and comprises 30 hash words (i.e. one for each of the consecutive frames). The hash is generated by firstly dividing each entire frame into equally sized, rectangular blocks. For each block, the mean of the luminance values of the pixels is computed. Then, in order to make the hash independent of the global level and scale of the luminance, the luminance differences between two consecutive blocks are computed. Also, to reduce the correlation of the hash words in the temporal direction, the difference of spatial differential mean luminance values in consecutive frames is also computed. Thus, in the resultant binary hash, each bit is derived from the mean luminances of a respective two consecutive blocks in a respective frame of the video signal and from the mean luminances of the same two blocks in an immediately preceding frame.

Although the method disclosed in WO02/065782 provides hashes having a certain degree of robustness, a problem remains in that the hashes are still sensitive to a number of the factors discussed above, in particular, although not exclusively, to transformations comprising scaling, shifting, and rotation, to changes in format, and to the frame rates of the signals from which they are derived.

### SUMMARY OF THE INVENTION

It is an object of the invention to provide a method of generating a fingerprint indicative of the content of a video signal which yields a fingerprint that is more robust, at least to a degree, with respect to at least one of the factors discussed above. It is an object of certain embodiments of the invention to provide fingerprints with improved robustness with respect to scaling and rotational changes.

A first aspect of the present invention provides a method of generating a fingerprint indicative of a content of a video signal comprising a sequence of data frames, the method comprising the steps of:

dividing only a central portion of each frame into a plurality of blocks, and leaving a remaining portion of each frame undivided into blocks, the remaining portion being outside the central portion;

extracting a feature of the data in each block; and

computing a fingerprint from said extracted features.

Thus, the method uses only the central portion of each frame to derive the fingerprint; the remaining, outer portion of each frame is ignored, in the sense that its contents do not contribute to the fingerprint. This method provides the advantage that the resultant fingerprint is more robust with respect to transformations comprising cropping or shifts, and is also particularly suited to the fingerprinting of video that is in letterboxed format.

It will be appreciated that the step of extracting a feature from a block may, for example, comprise calculation, such as the calculation of a property of pixels within that block.

Advantageously, in certain embodiments the remaining portion surrounds the central portion, such that the method ignores a certain amount of the frame above, below, and on either side of the central portion. This further improves robustness as it further concentrates the fingerprint on what is typically the most perceptually important part of the frame (in capturing the video signal, the camera operator will, of course, have typically positioned the main subject/action towards the center of the frame).

In certain embodiments, the central portion surrounds a middle portion of the frame, and the method further comprises the step of leaving the middle portion undivided into blocks. Thus, in addition to ignoring peripheral data, the method may also ignore a middle portion. This provides the advantage that the fingerprint is made more robust with respect to scaling and shifting transformations, to which the content of the middle portion is highly sensitive.

In certain embodiments, the plurality of blocks comprises blocks having a plurality of different sizes. This provides the advantage that different portions of the frame can be given different weighting (i.e. influence on the resultant fingerprint).

For example, in certain embodiments, the plurality of blocks comprises a plurality of rectangular blocks having a plurality of different sizes, and the size of the rectangular blocks increases in at least one direction moving outwards from a center of the frame. Thus, there are larger blocks towards the periphery of the central portion, and smaller blocks towards the center. This provides the advantage that the density of blocks is greater towards the center of the frame, hence the perceptually more significant part of the frame is given more influence over the eventual fingerprint.

In certain embodiments, the plurality of blocks comprises a plurality of non-rectangular blocks, and this provides the advantage that block shape can be selected to provide the resultant fingerprint with robustness to specific transformations.

For example, the plurality of non-rectangular blocks in some embodiments comprises a plurality of generally sectorial blocks, each said generally sectorial block being bounded by a respective pair of radii from a center of the frame. In other words, the blocks may be generally pie-segment shaped (although this general shape may be modified if the block is bounded at one radial end by a rectangular perimeter to the central portion, for example, and at the inner radial end by the shape of any middle portion excluded from the fingerprint generation process). Use of such block shape provides the advantage that the resultant fingerprints are particularly robust with respect to scaling transformations.

In certain embodiments, the plurality of non-rectangular blocks comprises a plurality of generally annular concentric blocks, providing the advantage that the fingerprints generated are particularly robust with respect to rotational transformations.

It will be appreciated that the step of ignoring a middle portion of each frame may be used in conjunction with any of the block shapes.

Other aspects of the invention provide methods of generating fingerprints as defined in claims 10 and 13, and their associated advantages will be appreciated from the above discussion.

Another aspect of the invention provides a method of generating a fingerprint indicative of a content of a video signal comprising a sequence of data frames, each data frame comprising a plurality of blocks, and each block corresponding to a respective region of a video image, the method comprising the steps of:

selecting only a subset of the plurality of blocks for each frame, the selected subset corresponding to a central portion of the video image;

extracting a feature of the data in each block of the selected subset; and

computing a fingerprint from said extracted features.

Thus, an aspect of the invention provides a method of generating a fingerprint from a signal that comprises frames already divided into blocks (such as a compressed video signal, for example). By deriving the fingerprint from only the central blocks, this aspect again provides the advantage that the fingerprint is more robust with respect to transformations comprising cropping or shifts, and is also particularly suited to the fingerprinting of video that is in letterboxed format.

If the video signal is a compressed signal, extraction of a feature from a block may comprise a calculation, or alternatively may comprise simply copying some part of the data within each block (such as the data in a block obtained via a DCT technique that is indicative of some DC component of the corresponding group of pixels in the uncompressed source signal).

Another aspect provides signal processing apparatus arranged to carry out the inventive method of any of the above aspects.

Further aspects provide a computer program enabling the carrying out of the inventive method of any of the above aspects, and a record carrier on which such a program is recorded.

Yet further aspects provide broadcast monitoring methods, filtering methods, automatic video library organization methods, selective recording methods, and tamper detection methods using the inventive fingerprint generation methods.

These and other aspects of the invention, and further features of embodiments of the invention and their associated advantages, will be apparent from the following description of embodiments and the claims.

### BRIEF DESCRIPTION OF THE DRAWINGS

Embodiments of the invention will now be described with reference to the accompanying drawings, of which:

FIG. 1 is a schematic representation of a fingerprint generation method embodying the invention;

FIG. 2 is a schematic representation of the selection of a central portion of a frame in another fingerprint generation method embodying the invention;

FIG. 3 is a schematic representation of the division of a central portion of a frame into blocks in yet another fingerprint generation method embodying the invention;

FIG. 4 is a schematic representation of the division of a frame into blocks in yet another fingerprint generation method embodying the invention;

FIG. 5 is a schematic representation of part of yet another fingerprint generation method embodying the invention, generating sub-fingerprints indicative of the content of a video signal;

FIG. 6 is a schematic representation of a video fingerprinting system embodying the invention;

FIG. 7 is a schematic representation of a frame of a video signal divided into blocks;

FIG. 8 is a schematic representation of part of a sequence of extracted feature frames generated in a method embodying the invention;

FIG. 9 is a schematic representation of the division of a frame of a video signal into blocks, as used in certain embodiments of the invention;

FIG. 10 is a schematic representation of the division of a frame of a video signal into blocks, as used in certain embodiments of the invention; and

FIG. 11 is a schematic representation of the division of a frame of a video signal into blocks, as used in certain embodiments of the invention.

### DESCRIPTION OF PREFERRED EMBODIMENTS

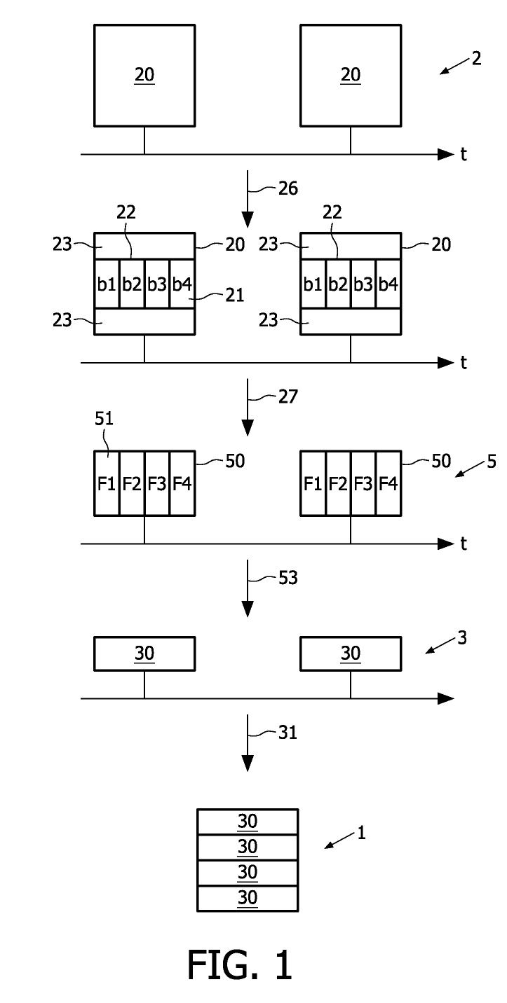

Referring now to FIG. 1, this is a highly schematic representation of a finger print generation method in accordance with the present invention. A video signal 2 comprises of a first series of data frames 20 having a first frame rate. For ease of representation, only two of the data frames 20 are shown in the figure. However, it will be appreciated that in practice the number of data frames in the signal whose fingerprint is being generated may be very much larger. The sequence of first data frames 20 is shown at positions along a time line. The frame rate of the sequence of frames 20 is constant. In other words, the data frames can be regarded as samples of an image content at regular time intervals. In certain embodiments video signal 2 is in the form of a file stored on some appropriate medium. In alternative embodiments, the signal 2 may be a broadcast signal, for example, such that the time interval between the two frames shown on the time line is the real time interval between the broadcast or transmission of successive frames (and hence also the real time interval between receipt of successive frames at some destination).

The method includes a processing step 26 which comprises dividing only a central portion 22 of each frame 20 into a plurality of blocks 21, and leaving a remaining portion 23 of each frame undivided into blocks, the remaining portion 23 being outside the central portion. In this first embodiment, the central portion 22 is the full width of the frame, and the remaining portion 23 comprises two bands (rectangular regions), above and below the central portion. In alternative embodiments, however, the central portion selected may have a different shape and/or extent, as will be appreciated from the further description below. For simplicity, in FIG. 1 the central portion 22 is shown divided into just four blocks, b1-b4. In practice, however, a larger number of blocks may be used.

The method then further includes a processing step 27 of extracting a feature F of the data in each block 21, and a step of computing a fingerprint 1 from the extracted features. In this example, the step of extracting features comprises generating a sequence 5 of extracted feature frames 50, having the same frame rate as the source signal 2. Each extracted feature frame 50 contains feature data F1-F4 corresponding to each of the blocks 21 into which the central portions 22 were divided. The step of computing the fingerprint 1 in this example includes a processing step 53, comprising generating a sequence 3 of sub-fingerprints 30 at the source frame rate, from the extracted feature frames 50, and a further processing step 31 which operates on the sequence 3 of sub-fingerprints 30 and concatenates them to form a fingerprint 1. Each of the sub-fingerprints 30 is derived from and dependent upon a data content of the central portion at least 1 frame of the source video signal, and the resultant fingerprint 1 is indicative of a content of the signal 2. It will be appreciated, however, that the fingerprint is independent of any content of the original signal contained in the remaining portion 23 of each frame. Thus, the fingerprint effectively ignores the content of the source signal in the bands above and below the central portion 22.

As was the case with the source video signal, the sequence 3 of sub-fingerprints produced by the processing step 23 may be in the form of a file stored on a suitable medium, or alternatively may be a real-time succession of sub-fingerprints 30 output from a suitably arranged processor.

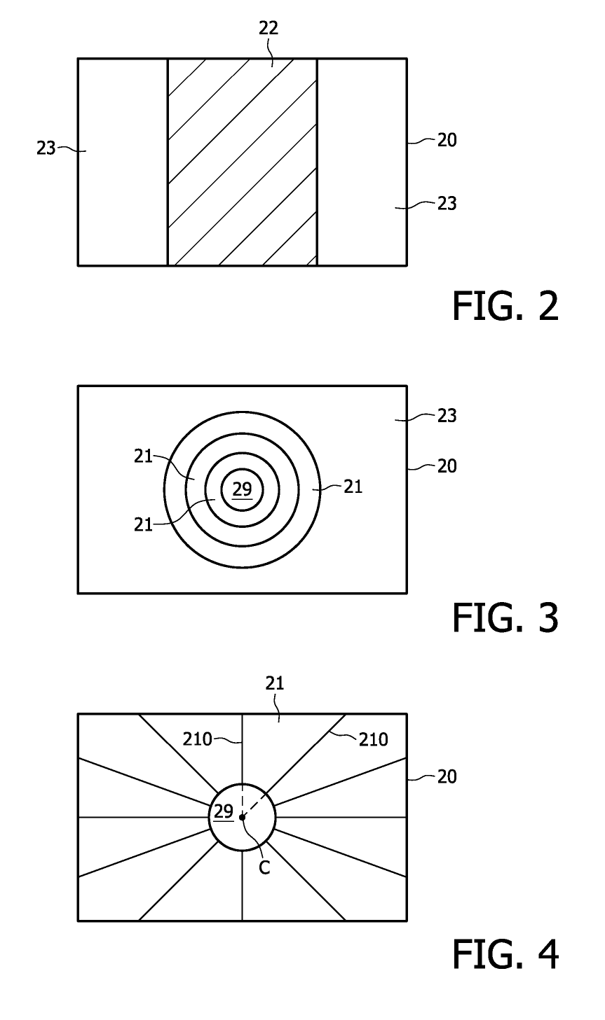

Referring now to FIG. 2, in alternative embodiments the central portion 22 of each frame 20, from which the fingerprint is derived, does not extend to the full width of the frame 20. In this example, the central portion 22 does, however, extend to the full height of the frame, with the remaining portion 23 comprising vertical bands on either side.

FIG. 3 illustrates the division of a video frame into blocks in another embodiment of the invention. Here, the central portion has a circular outer perimeter, and the remaining portion 23 surrounds the central portion. Furthermore, the central portion surrounds a middle portion 29 of the frame, and that middle portion 29 is undivided into blocks. The fingerprint generation method thus ignores the data content of both the middle portion 29, at the center of the frame, and the peripheral portion 23. The central portion in this example is generally annular, and is divided into a plurality of annular blocks 21 (in other words, in this example the blocks are rings). Use of annular blocks provides the advantage of rotation robustness in the eventual fingerprint.

Referring now to FIG. 4, in certain other embodiments each frame 20 is divided into a plurality of non-rectangular blocks. In this example, each block 21 is generally sectorial (i.e. generally in the shape of a pie portion), being bounded by a respective pair of radii 210 from a nominal center C of the frame, and by the frame perimeter and the perimeter of a middle portion 29, which is again excluded from the block division process. Use of sectorial blocks 21 and exclusion of the center 29 provides the advantage that a resultant fingerprint exhibits robustness to scaling.

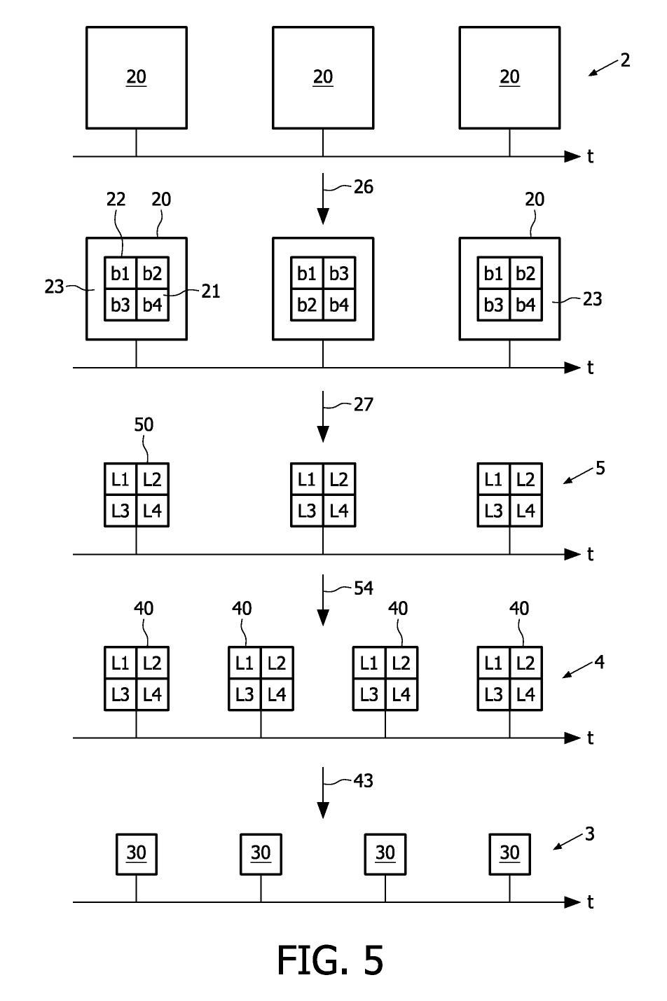

Referring now to FIG. 5, this shows part of a fingerprint generation method embodying the invention for generating digital fingerprints of an information signal 2 in a form of a video signal comprising a sequence of video frames 20, each containing pixel data. The method comprises a processing step 26 of dividing a central portion 22 of each of the source frames 20 into a plurality of blocks 21. For simplicity, each central portion 22 is shown divided into just four blocks 21, which are labeled b1-b4. It will be appreciated that this number of blocks is just an example, and in practice a different number of blocks may be used. The method further comprises the steps of calculating a feature of each block 21 and then using the calculated feature data produce the sequence 5 of extracted feature frames 50 such that each extracted feature frame 50 contains the calculated block feature data for each of the plurality of blocks of the respective one of the first sequence of frames. In the illustrated example, the feature calculated in processing step 27 is the mean luminance L of the group of pixels in each block 21. Thus, each extracted feature frame 50 contains four mean luminance values, L1-L4. Then, in processing step 54, a second sequence 4 of data frames 40 is constructed from the sequence 5 of extracted feature frames. Each of the second sequence of frames 40 contains four mean luminance values, one for each of the four blocks into which the source frames were divided. The second sequence 4 of data frames 40 in this embodiment is at a predetermined rate, independent of the frame rate of the source video signal 2. This predetermined rate is, therefore, in general different to the source frame rate, and so some of the second sequence frames 40 correspond to positions on the time line which are between positions of the extracted feature data frames 50. Thus, in this example the mean luminance values contained in the second sequence data frames 40 are derived from the contents of the extracted feature frames 50 by a process comprising interpolation. In the figure, the first illustrated frame of the second sequence 4 corresponds exactly to the position on the time line of the first sequence of the extracted feature frames 50, and hence the mean luminance value it contains can simply be copied from that extracted feature frame 50. However, the second in the sequence of data frames 40 occurs at a position in the time line that is between the first and second extracted feature frames 50. Accordingly, each of the mean luminance values in this second frame 40 has been derived by a process involving a calculation using two mean luminance values from the “surrounding” extracted feature frames 50 on the time line. Then, in processing step 43, the sequence of sub-fingerprints 30 is calculated (i.e. derived) from the block mean luminance values in the sequence of data frames 40. In this example, each sub-fingerprint 30 is derived from the contents of a respective one of the second sequence 4 of frames 40 and from the immediately preceding frame 40 in that second sequence 4.

The sequence of sub-fingerprints, at the independent rate, can then be processed to provide a fingerprint which has a degree of frame rate robustness, and robustness to transformations such as cropping and shifts, as a result of the fingerprint being derived only from the central portions 22 of the source frames.

Further background information relating to the fingerprinting of information signals, and video signals in particular, will now be given, along with descriptions of further embodiments and further features of embodiments of the invention.

A video fingerprint, in certain embodiments, is a code (e.g. a digital piece of information) that identifies the content of a segment of video. Ideally, a video fingerprint for a particular content should not only be unique (i.e. different from the fingerprints of all other video segments having different contents) but also be robust against distortions and transformations.

A video fingerprint can also be seen as a short summary of a video object. Preferably, a fingerprint function F should map a video object X, consisting of a large and variable number of bits, to a fingerprint consisting of only a smaller and fixed number of bits, in order to facilitate database storage and effective searching (for matches with other fingerprints).

The requirements of a video fingerprint for it to be a good content classifier can also be summarized as follows: ideally, the fingerprints of a video clip are unique, implying that the probability of fingerprints of different video clips being similar is low; and fingerprints for different versions of same video clip should be similar, implying that the probability of similarity of the fingerprints of an original video and its processed version is high.

Some definitions useful in understanding the following description are as follows:

a sub-fingerprint is a piece of data indicative of the content of part of a sequence of frames of an information signal. In the case of video signals, a sub-fingerprint is, in certain embodiments, a binary word, and in particular embodiments is a 32 bit sequence. In embodiments of the invention a sub-fingerprint may be derived from and dependent upon the contents of more than one source frame;

a fingerprint of a video segment represents an orderly collection of all of its sub fingerprints;

a fingerprint block can be regarded as a sub-group of the “fingerprint” class, and in certain embodiments is a sequence of 256 sub fingerprints representing a contiguous sequence of video frames;

metadata is oft information of a video clip consisting of parameters like ‘name of the video’, ‘artist’ etc., and an end-application would be interested in getting this metadata; Hamming distance: In comparing two bit patterns, the Hamming distance is the count of bits different in the two patterns. More generally, if two ordered lists of items are compared, the Hamming distance is the number of items that do not identically agree. This distance is applicable to encoded information, and is a particularly simple metric of comparison, often more useful than the city-block distance (the sum of absolute values of distances along the coordinate axes) or Euclidean distance (the square root of the sum of squares of the distances along the coordinate axes).

Bit Error Rate (BER): Bit error rate between two fingerprints is the fraction representing the number of dissimilar bits in the two. In may also be termed as the ratio of Hamming Distance between the bit strings of two fingerprint block to the number of bits in a fingerprint block (i.e. 256×32=8192).

Inter-Class BER Comparison: Inter-Class BER refers to the bit error rate between two fingerprint blocks corresponding to two different video sequences.

Intra-Class BER Comparison: Intra class BER comparison refers to the bit error rate between two fingerprint blocks belonging to the same video sequence. It may be noted that two video sequences may be different in the sense that they might have undergone geometrical or other qualitative transformations. However, they are perceptually similar to the human eye.

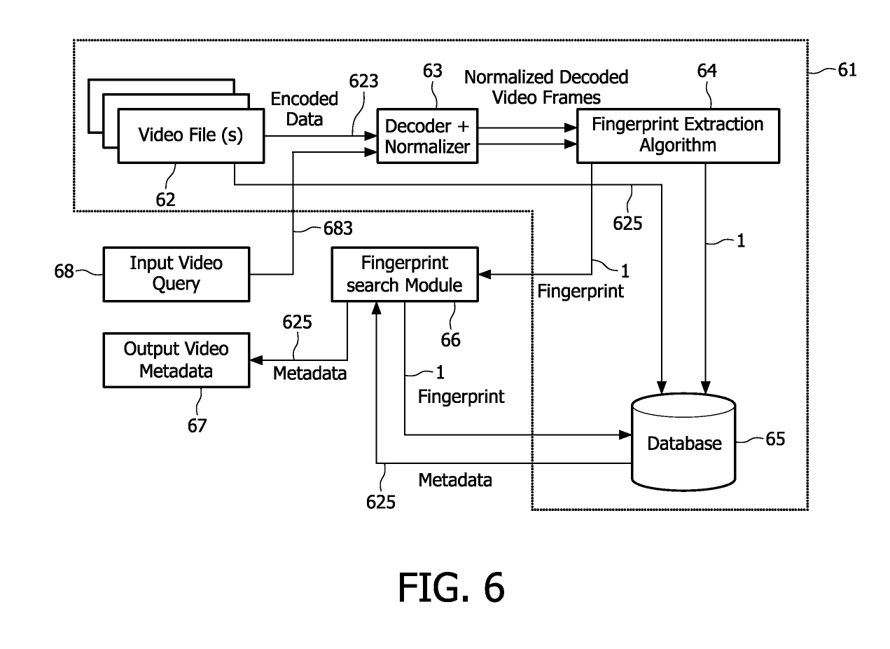

A video fingerprinting system embodying the invention is shown in FIG. 6. This video fingerprinting system provides two functionalities: fingerprint generation; and fingerprint identification. Fingerprint generation is done both during the pre-processing stage as well as identification stage. In the pre-processing stage, the fingerprints 1 of the video files 62 (movies, television programmes and commercials etc.) are generated and stored in a database 65. FIG. 6 shows this stage in box 61. During the identification stage, the fingerprints 1 are again generated from such sequences (input video queries 68) and are sent to the system as a query. The fingerprint identification stage consists primarily of a database search strategy. It may be noticed that owing to the huge amount of fingerprints in the database, it is practically not possible to use a brute-force approach to search fingerprints. A different approach to search fingerprints efficiently in real-time has been adopted in certain embodiments of the invention. The input in this stage is a fingerprint block query 68 and output is a metadata 625 consisting of identification result(s).

In slightly more detail, in the embodiment shown in FIG. 6, encoded data 623 from video files 62 is normalized (which, for example, may comprise scaling the video resolution to a fixed resolution) and decoded by a decoder and normalize 63. This stage 63 then provides normalized decoded video frames to a fingerprint extraction stage 64, which processes the incoming frames with a fingerprint extraction algorithm to generate a fingerprint 1 of the source video file. This fingerprint 1 is stored in the database 65 along with corresponding metadata 625 for the video file 62. An input video query 68 comprises encoded data 683 which is also processed by the decoder/normalize 63, and the fingerprint extraction stage 64 generates a fingerprint 1 corresponding to the query and provides that fingerprint to a fingerprint search module 66. That module searches for a matching fingerprint in the database 65, and when a match is found for the query, the corresponding metadata 625 is provided as an output 67.

Parameters to consider in a video fingerprint system are as follows:

Robustness: can a video clip still be identified after severe signal degradation? In order to achieve high robustness, the fingerprint should be based on perceptual features that are invariant (at least to a certain degree) with respect to signal degradations. Preferably, severely degraded video still leads to very similar fingerprints. The false rejection rate (FRR) is generally used to express the robustness. A false rejection occurs when the fingerprints of perceptually similar video clips are too different to lead to a positive match.

Reliability: how often is a movie incorrectly identified? The rate at which this occurs is usually referred to as the false acceptance rate (FAR).

Fingerprint size: how much storage is needed for a fingerprint? To enable fast searching, fingerprints are usually stored in RAM memory. Therefore the fingerprint size, usually expressed in bits per second or bits per movie, determines to a large degree the memory resources that are needed for a fingerprint database server.

Granularity: how many seconds of video is needed to identify a video clip? Granularity is a parameter that can depend on the application. In some applications the whole movie can be used for identification, in others one prefers to identify a movie with only a short excerpt of video.

Search speed and scalability: how long does it take to find a fingerprint in a fingerprint database? What if the database contains thousands of movies? For the commercial deployment of video fingerprint systems, search speed and scalability are a key parameter. Search speed should be in the order of milliseconds for a database containing over 10,000 movies using only limited computing resources (e.g. a few high-end PC's).

Effect of transformations on fingerprints: video fingerprints can change due to different transformations and processing applied on a video sequence. Such transformations include smoothening and compression, for example. These transformations result in different fingerprint blocks for an original video sequence and the transformed sequence and hence a bit error rate (BER) is incurred when the fingerprints of the original and transformed versions are compared. In certain cases compression to a low bit rate can be is a highly severe process compared to mere smoothening (noise reduction) of the frames in the video sequence. The BER in the former case is therefore much higher than the latter.

The correlation between the two fingerprint blocks also varies depending upon the severity of transformation. The less severe the transformation, the higher is the correlation.

Searching for fingerprints in a database is not an easy task. A search technique which may be used in embodiments of the invention is described in WO 02/065782. A brief description of the problem is as follows.

In certain embodiments of the invention, the video fingerprint system generates sub-fingerprints at 55 Hz. Hence, from a video of duration of 2 hours the number of sub-fingerprints generated would be: (2×60×60) s×55 sub-fingerprints/s=396000 sub-fingerprints. In a database consisting of fingerprints of 2000 hours of video (396 million sub-fingerprints), it would not be possible for a brute force search algorithm to produce result in real-time. The search task has to find the position in the 396 million sub-fingerprints. With brute force searching, this takes 396 million fingerprint block comparisons. Using a modern PC, a rate of approximately 200,000 fingerprint block comparisons per second can be achieved. Therefore the total search time for our example will be in the order of 30 minutes.

The brute force approach can be improved by using an indexed list. For example, consider the following sequence:

### “AMSTERDAMBERLINNEYYORKPARISLONDON”

We could index the list by the starting letter of each city. If we want to lookup for the word “PARIS”, we could go directly to the sub-list for “P” and search for the word. However, the situation in case of fingerprints is not as easy as depicted in this example. This is evident from the question: will the query contain the exact word “PARIS”? The query can contain “QARIS”, “QBRIS”, “QASIS”, “PBRHS” or even “OBSJT” or some other near word. Hence, there is a possibility that we might not even get a correct starting position in the index to start out search and the system would falsely reject the scaled version of the clip. The solution is to find close matches. Hence, when unable to find an exact match for the query word “OBSJT” each of the letters in this word is toggled and a match is searched for the resulting word.

Thus, in certain embodiments of the invention, while calculating the sub-fingerprints, each bit in a sub-fingerprint is ranked according to its strength. When an exact match is not found for any of the sub-fingerprints (letters), the weak bits are toggled of the sub-fingerprints, in the increasing order of their strength. Hence, the weakest bit is toggled first, a match is searched for the resulting new fingerprint; if a match is not found then the next weakest bit is toggled and so on. In case more than one match is found by toggling the pre-defined number of maximum bits, the one with least BER (<threshold) is deemed as the fairly closest match. Hence, if the query is “QARIS” and the strength estimation algorithm ranks “Q” as the weakest bit, the match would be found instantaneously after toggling “Q” to P for example. However, if “Q” is ranked as strongest, the search would take a longer time.

In the analysis of performance of algorithms, the term database hits is used frequently. A database hit represents the situation when the match (which may be an exact match, or a close match) is found in the database.

Video fingerprinting applications of embodiments of the invention will now be discussed in more detail. Apart from video fingerprinting, there are other technologies, such as watermarking, available for the identification of video sequences within third-party transmissions. This process, however, relies on a video sequence being modified and the watermark being inserted into the video stream; this is then retrieved from the stream at a later time and compared with the database entry. This requires the watermark to travel with the video material. On the other hand, a video fingerprint is stored centrally and it does not need to travel with the material. Therefore, video fingerprinting can still identify material after it has been transmitted on the web. A number of applications of video fingerprinting have been considered. They are listed as follows:

Filtering Technology for File Sharing: The movie industry throughout the world suffers great losses due to video file sharing over the peer to peer networks. Generally, when the movie is released, the “handy cam” prints of the video are already doing rounds on the so-called sharing sites. Although, the file sharing protocols are quite different from each other, yet most of them share files using un-encrypted methods. Filtering refers to active intervention in this kind of content distribution. Video fingerprinting is considered as a good candidate for such a filtering mechanism. Moreover, it is than other techniques like watermark that can be used for content identification as a watermark has to travel with the video, which cannot be guaranteed. Thus, one aspect of the invention provides a filtering method and a filtering system utilizing a fingerprint generation method in accordance with the first aspect of the invention.

Broadcast Monitoring: Monitoring refers to tracking of radio, television or web broadcasts for, among others, the purposes of royalty collection, program verification and people metering. This application is passive in the sense that it has no direct influence on what is being broadcast: the main purpose of the application is to observe and report. A broadcast monitoring system based on fingerprinting consists of several monitoring sites and a central site where the fingerprint server is located. At the monitoring sites fingerprints are extracted from all the (local) broadcast channels. The central site collects the fingerprints from the monitoring sites. Subsequently the fingerprint server, containing a huge fingerprint database, produces the play lists of the respective broadcast channel. Thus, another aspect of the invention provides a broadcast monitoring method and a broadcast monitoring system utilizing a fingerprint generation method in accordance with the first aspect of the invention.

Automated indexing of multimedia library: Many computer users have a video library containing several hundreds, sometimes even thousands, of video files. When the files are obtained from different sources, such as ripping from a DVD, scanning of image and downloading from file sharing services, these libraries are often not well organized. By identifying these files with fingerprinting the files can be automatically labeled with the correct metadata, allowing easy organization based on, for example, artist, music album or genre. Thus, another aspect of the invention provides an automated indexing method and system utilizing a fingerprint generation method in accordance with the first aspect of the invention.

Television Commercial Blocking and Selective Recording: Television commercial blocking can be accomplished in a digital broadcast scenario. For example, in a Multimedia Home Platform (MHP) scenario based on Digital Video Broadcasting (DVB) standard, the television is connected to the outside world. With one of such connections to the fingerprinting server and television equipped with fingerprint generation capability, the television commercials can be blocked from the viewer. This application can also be used as an enabling tool for selective recording of programs with the added advantage of commercials filtering. Thus, other aspects of the invention provide commercial blocking and selective recording methods and systems utilizing fingerprint generation methods in accordance with the first aspect of the invention.

Detection of Video Tampering or Error in Transmission Lines: As discussed above, the fingerprints of an original movie and its transformed (or processed) version are generally different from each other. The BER function can be used to ascertain the difference between the two. This property of the fingerprints can be used to detect the malfunctioning of a transmission line which is supposed to transmit a correct video sequence. Also, it can be used to automatically detect (without manual intervention), if a movie or video material has been tampered with. Thus, other aspects of the invention provide tampering and error detection methods and systems utilizing fingerprint generation methods in accordance with the first aspect of the invention.

Video fingerprint tests have been used to evaluate fingerprint extraction algorithms used in embodiments of the invention. These tests have included reliability tests and robustness tests. Reliability of the fingerprints generated by an algorithm is closely related to false acceptance rate. In reliability tests the BER distribution of bits resulting from comparison of two fingerprint blocks have been studied, to provide theoretical false acceptance rate. Inter-Class BER distribution serves as a robust indicator of the performance of the algorithm, for example.

In robustness tests, used to evaluate fingerprint extraction algorithms used in embodiments of the invention, a small database consisting of 4 video clips and several of their transformed versions was created. A video can undergo several transformations. In order to test the fingerprinting algorithms developed, the following transformations on images were considered: scaling; horizontal scaling; vertical scaling; rotation; upward shift; downward shift; CIF (Common Interchange Format) Scaling; QCIF (Quarter Common Interchange Format) Scaling; SIF (Standard Common Interchange Format) Scaling; median filtering; change in brightness; change in contrast; compression; change in frame rate. Thus, transformed versions of an original clip, using these different transformations, were made and the fingerprints of the original and transformed versions compared.

Algorithms used in video fingerprinting methods and systems embodying the invention will now be described. Firstly, a so-called differential block luminance algorithm will be described. Improvements to the basic algorithm, to increase the robustness of the algorithm, are then discussed.

In the Differential Block Luminance Algorithm, the algorithm computes features in the spatio-temporal domain. Moreover, one of the major applications for video fingerprinting is filtering of video files on peer-to-peer networks. The stream of compressed data available to the system can be used beneficially, if the feature extraction uses block-based DCT (discrete cosine transformation) coefficients.

The guiding principles of this algorithm are as follows:
1. To obtain features uniquely representing the video sequence on a frame by frame basis.
2. To obtain perceptually important features. It may be noticed that in an image, the luminance feature is more important compared to color components. Also, YUV color space is universally accepted primary sub-sampling encoder for all the video encoders. Hence luminance values are used to extract features.
3. To allow easy feature extraction from most compressed video streams as well, we choose features which can be easily computed from block-based DCT coefficients. Based on these considerations, the proposed algorithm is based on a simple statistic, the mean luminance, computed over relatively large regions.

The sub-fingerprints are extracted as follows.

1. Each video frame is divided in a grid of R rows and C columns, resulting in R×C blocks. For each of these blocks, the mean of the luminance values of the pixels is computed. The mean luminance of block (r, c) in frame p is denoted F(r, c, p) for r=1, 2, . . . , R and c=1, 2, . . . , C.

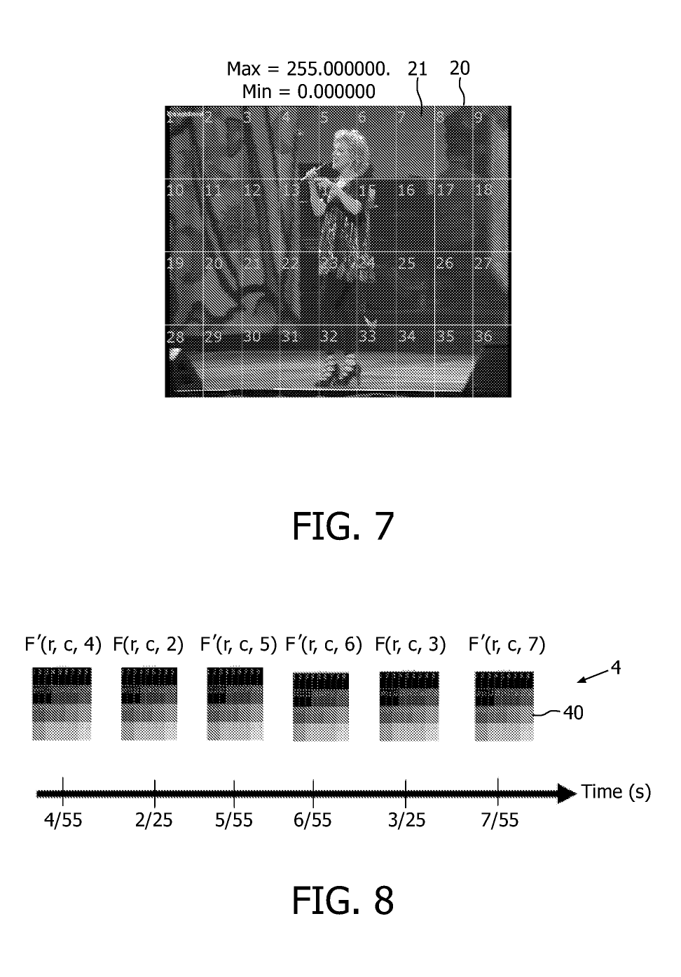

FIG. 7 illustrates a video data frame 20 divided into blocks 21 in this way. The representation of the frame shows the R×C blocks for R=4 and C=9 (i.e. 36 blocks in total in this example). The mean of the luminance values is calculated for each of the blocks resulting in R×C mean values. Each of the numbers represents a corresponding region in the input video frame. Thus, the means of the luminance values in each of these regions has been calculated.

2. The computed mean luminance values in step 1 can be visualized as R×C “pixels” in a frame (an extracted feature frame). In other words, these represent the energy of different portions of the frame. A spatial filter with kernel [−1 1] (i.e. taking differences between neighboring blocks in the same row), and a temporal filter with kernel [−α 1] is applied on this sequence of low resolution gray-scale images. Hence, if we consider M13 and M14 to be the mean values originating from regions 13 and 14 on current frame and M′ 13 and M′ 14 to be the mean values coming from corresponding regions in next frame then the value (called soft sub-fingerprint) is computed as

$${SftFP}_{13} = [ \begin{matrix}{M}_{14}^{′} & {M}_{13}^{′}\end{matrix} ] [ \begin{matrix}- 1 \\ 1\end{matrix} ] - α \cdot [ \begin{matrix}{M}_{14} & {M}_{13}\end{matrix} ] [ \begin{matrix}- 1 \\ 1\end{matrix} ]$$

3. The sign value of SftFPₙ, determines the value of the bit in the sub-fingerprint. More specifically,

$$for n = 1 … 32 , {bit}_{n} = \{ \begin{matrix}0 , & if {SftFP}_{n} < 0 \\ 1 , & if {SftFP}_{n} \geq 0\end{matrix}$$

Summarizing and more precisely, we have for r=1, 2, . . . , R and c=1, 2, . . . C

$$B ( r , c , p ) = \{ \begin{matrix}1 , & if Q ( r , c , p ) \geq 0 \\ 0 , & if Q ( r , c , p ) < 0\end{matrix} \}$$

where

Q(r,c,p)=(F(r,c+1,p)−F(r,c,p))−a·(F(r,c+1, p−1)−F(r,c,p−1))

This algorithm is called “differential block luminance algorithm”. It yields a sequence of sub-fingerprints, one sub fingerprint for each of the “source” image frames it acts on, the bits of those sub-fingerprints being given by B(r,c,p) above.

In this algorithm, alpha can be considered to be a weighting factor, representing the degree to which values in the “next” frame are taken into account. Different embodiments may use different values for alpha. In certain embodiments, alpha equals 1, for example.

We shall now discuss the problem of robustness against variable frame rate in relation to the above-algorithm. In motion pictures, television, and in computer video displays, the frame rate is the number of frames or images that are projected or displayed per second. Frame rates are used in synchronizing audio and pictures, whether film, television, or video. Frame rates of 24, 25 and 30 frames per second are common, each having uses in different portions of the industry. In the U.S., the professional frame rate for motion pictures is 24 frames per second and, for television, 30 frames per second. However, these frame rates are variable because different standards are followed in the video broadcast throughout the world. The basic differential block luminance fingerprint extraction algorithm described above works on a frame by frame basis. Hence, the sub-fingerprint generation rate is same as that of frame rate provided by the video source; e.g. if fingerprints are extracted from a movie being broadcast in USA, 30 sub-fingerprints would be extracted in a second. Therefore, the corresponding fingerprint block stored in the database would represent 256/30=8.53 s of video. If a video query from Europe is given to the system, it would have a frame rate of 25 Hz. In this case, a fingerprint block would represent 256/25=10.24 s of video. In principle, these two fingerprint blocks would not match with each other as they represent two different time frames.

Looking at this in general terms, a fingerprint system may provide essentially two functions. Firstly, fingerprints are generated for storage in a database. Secondly, fingerprints are generated from a video query for identification purposes. In general, if video sources in these two stages have frame rates as ν and μ respectively, then the fingerprint blocks (consisting of 256 sub-fingerprints) in these two cases would represent (256/ν) seconds and (256/μ) seconds of video respectively. These time frames are different and hence their sub-fingerprints generated during these durations come from different frames. Hence, they would not match.

A modification of the basic differential block mean luminance algorithm, to provide a degree of frame rate robustness, is described below.

Frame rate robustness in embodiments of the invention is incorporated by generating sub-fingerprints at a constant rate irrespective of the frame rate of the video source. The two most common frame rates of video are 25 (PAL) and 30 (NTSC) Hz. One choice for a predetermined sub-fingerprint generation rate would then be the mean of these two i.e. (25+30)/2=27.5. Hence, a fingerprint block formed from 256 sub-fingerprints generated at this rate would represent 256/27.5=9.3 s of video. In some of the applications of video fingerprinting (like television commercial blocking), a higher granularity might be required. Hence, in certain embodiments, an alternative (higher) frequency of 27.5×2=55 Hz is used for fingerprint generation. The further examples mentioned below use this frequency of fingerprint extraction (but it will be appreciated that the frequency is itself just one example, and further embodiments may utilize different predetermined frequencies).

In order to incorporate frame rate robustness in the differential block mean luminance algorithm, changes are made between steps 1 and 2 in the algorithm mentioned above. If the frequency of the video source is ν Hz then the sequence of F(r, c, p) . . . F(r, c, p+ν) is interpolated to 55 Hz. This process leads to the generation of 55 sub-fingerprints every second (except the 1st second where 54 sub-fingerprints would be generated, as p≧1). This makes the sub-fingerprint generation independent of video source's frame rate. The sub-fingerprints generated would now represent the frames in term of a constant time frame irrespective of the time frame of the video source. FIG. 8 illustrates the scenario explained above. Suppose the video frame has frequency of 25 Hz. Hence, F(r, c, 2) and F(r, c, 3) represent the mean frames at times 2/25 and 3/25 respectively. The mean frames F′(r, c, 4), F′(r, c, 5), F′(r, c, 6) and F′(r, c, 7) represent the linearly interpolated mean frames at times 4/55, 5/55, 6/55 and 7/55 respectively. In other words, the contents of these linearly interpolated mean frames have been constructed, by calculation from the contents of the mean frames that were obtained directly from the source frame sequence. Thus, the modified algorithm comprises the generation of a sequence of extracted feature frames (containing mean luminance values) having the predetermined frame rate (55 Hz in this example), the contents of those frames being derived from the contents of the source frames (via the sequence of directly extracted feature frames) by a process comprising interpolation (where necessary). Although linear interpolation is used in the above example, other interpolation techniques may be used in alternative embodiments.

Properties of the fingerprints resulting from the modified differential block mean luminance algorithm described above (using interpolation to produce extracted feature frames at the predetermined rate) have been analyzed, including performing tests to evaluate the bit error rate due to various transformations discussed above. In tests, a searching strategy as described above (using toggling of bits) was used to look for close matches of fingerprints of original versions and fingerprints of transformed versions, in addition to searches for exact matches.

The following features were noticed from the results:

A good degree of frame-rate robustness was achieved.

However, horizontal scaling and vertical scaling, if large, could lead to high BERs. This can be understood from the fact that during horizontal and vertical scaling, the pixels in the frame move to the neighboring blocks. This results in the calculation of a different mean. The effect of horizontal scaling is more prominent as the size of blocks is smaller horizontally than vertically. Hence the means do not change much in case of vertical scaling and hence this results in lesser BER.

Like scaling, large rotations could result in a high BER as well.

Clips which were stationary or had large amounts of dark regions tended to yield lower BERs compared to their fast and bright counterparts.

In certain cases it was not possible to find even a single exact match when the transformations are as severe as large amount of scaling or rotation. However in the case of rotation, it was possible to find close matches. Also, in case of compression to a very low bit rate the number of close matches went up substantially. Toggling the weak bits in order to find a close match helps in increasing the robustness of the algorithm against various transformations.

Thus, although the above-described fingerprint generation method, using the modified differential block mean luminance algorithm, provides much improved frame rate robustness with regard to prior art techniques, tests indicated that the algorithm was vulnerable to high amounts of scaling and rotation. Further modifications have therefore been made to the algorithm, and are described below. The modifications aimed to make the algorithm more robust to scaling and rotation in particular.

A first further modification will be described as a Centrally-Oriented Differential Block Luminance Algorithm. This algorithm differs from the previous one in that it takes into consideration more representative features of the frame. In order to do so, it extracts the fingerprints from central portions of the video frame. Development of this modified algorithm was based on an appreciation of the following:

a) It was noticed from use of the previous algorithm that black portions of the frame contributed very little information to the fingerprints. However, many of the video formats are ‘letterboxed’. Letterboxing is the practice of copying widescreen film to video formats while preserving the original aspect ratio. Since the video display is most often a squarer aspect ratio than the original film, the resulting master must include masked-off areas above and below the picture area (these are often referred to as “black bars”, resembling a letterbox slot). The reliability of the fingerprints can be increased by not taking the fingerprints of these areas.

b) Generally, most of the movements in a video frame are oriented-oriented. This can be understood from the fact that the cameraman would focus his camera towards the center of the scene being shot.

c) Sometimes, the movies contain subtitles in the bottom of each of the frame. These subtitles are generally constant over a number of frames and do not qualitatively induce any information towards the fingerprint.

d) The movies can also contain logos at the top which remain constant for the entire length of the movie. These logos are also present in different movies under the same production banner.

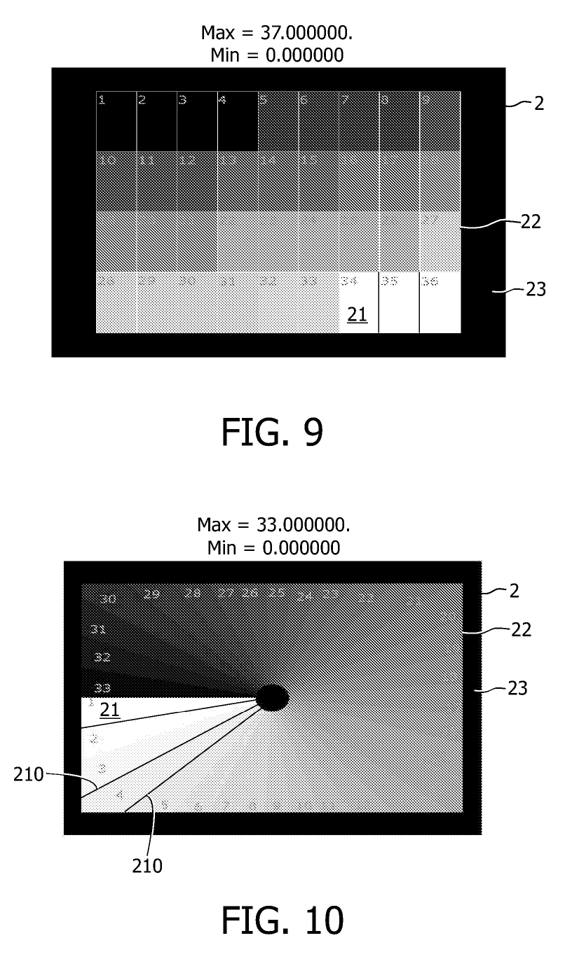

Taking these factors into account, the centrally oriented differential block mean luminance algorithm is very similar to the differential block luminance algorithm. However, the centrally oriented algorithm differs in the step where it divides a source frame into blocks. Instead of dividing the entire frame into blocks, these blocks or regions 21 are defined as shown in FIG. 9. Thus, only a central portion 22 of the frame 20 has been divided into blocks 21; the portions 23 in the outskirts of the frame have not been used. This helps in improving reliability. Having divided the frames into blocks in this way, the remainder of the algorithm calculates a sequence of sub-fingerprints in exactly the same way as the previously described algorithm. Thus, the means of the luminance values in each of the blocks/regions is calculated, resulting in 36 mean values for each frame (36 is just an example, however—a different number of blocks may again be used). Similarly, the mean values are collected from the next frame. Frame rate robustness may be incorporated at this stage by constructing/producing interpolated mean-frames to form the sequence at the desired, predetermined frame rate (and, indeed, the subsequent results for CODBLA are based on the algorithm including the frame rate robustness feature).

Tests have been performed to analyze the performance of the centrally oriented differential block luminance algorithm (CODBLA) with respect to the previous full-frame (non-centrally oriented) differential block luminance algorithm (again, incorporating frame rate robustness) (DBLA). The performance of the CODBLA was found to be better, in terms of the robustness of the resultant fingerprints, in certain cases, for example in the case of transformations comprising cropping or shifts. This result can be understood because the top portions of the video frames generally do not have much movement and hence they do not contribute much information. Also, the CODBLA is particularly suited to fingerprinting of video that is in letterboxed format.

Building on the principle of the CODBLA (concentrating on the central portions of the frame), the fingerprint extraction algorithm was further modified to improve robustness to scaling and rotational transformations. This yielded the Differential Pie-Block Luminance Algorithm (DPBLA), as follows.

The Differential Pie-Block Luminance Algorithm is different from the previous ones as it takes into consideration the geometry of the video frame. It extracts features from the frame in blocks shaped like sectors which are more resistant to scaling and shifting. In the CODBLA the means of luminance were extracted from rectangular blocks. These means were representative of that portion of the frame and provided a representative bit (in a sub-fingerprint) after spatio-temporal filtering and thresholding. A sequence of these bits represented a frame. However, use of rectangular blocks rectangular is vulnerable to scaling. Hence, when the video frame is scaled, the portions of the frame covered by the blocks are also scaled and do not represent the original portion uniquely. Hence, in the DPBLA the means (i.e. mean luminance values or data) are extracted from portions of the frame which are shaped like sectors of a circle and are resistant to horizontal scaling. In other words, in the DPBLA, the step of dividing a frame into blocks comprises dividing the frame into blocks as shown in FIG. 10. Again, only a central portion 22 of the frame is divided into blocks 21 (so this particular DPBLA is also centrally oriented). An outer, peripheral portion 23 is excluded, as is a middle, circular portion 29. Each block 21 is generally sectorial, lying between a respective pair of radii.

Apart from this difference in the block division step, the DPBLA operates to generate sub-fingerprints from luminances of pixels in the blocks in the same way as the DBLA and the CODBLA. In this particular example of the DPBLA the video frame 20 is divided into 33 “blocks” 21 in order to extract 32 values by clockwise spatial-differential explained below. The blocks are now shaped similar to the sectors of a circle. The uniform increase in the area of the sectors in the radial direction makes them more resistant to scaling. It may be noticed that the portions 23 in the outskirts of the frame have not been used. Also, the middle portion 29 of the frame has not been used for calculating means. This portion is highly vulnerable to scaling, shifting and even small amount of rotation. This helps in improving reliability. Each of the numbers represents a corresponding region in the input video frame. The means of the luminance values in each of these regions is calculated. This process results in 33 mean values.

The frame rate robustness can be applied at this stage to get the interpolated mean-frames. This procedure has been described in detail above, and will not be repeated here. Unlike the previous two algorithms, in this case a small difference is that the frames are represented as F(n, p) instead of as F(r, c, p). Hence the mean frames are interpolated likewise. The computed mean luminance values in step 1 can be visualized as 33 “pixel regions” in a frame. In other words, these represent the energy of different regions of the frame. A spatial filter with kernel [−1 1] (i.e. taking differences between neighboring blocks in the same row), and a temporal filter with kernel [−1 1], as explained, is applied on this sequence of low resolution gray-scale images.

Hence, if we consider M13 and M14 to be the mean values originating from regions 13 and 14 on current frame and M′13 and M′14 to be the mean values coming from corresponding regions in next frame then the value (called soft sub-fingerprint) is computed as

$${SftFP}_{13} = [ \begin{matrix}{M}_{14}^{′} & {M}_{13}^{′}\end{matrix} ] \cdot [ \begin{matrix}- 1 \\ 1\end{matrix} ] - [ \begin{matrix}{M}_{14} & {M}_{13}\end{matrix} ] \cdot [ \begin{matrix}- 1 \\ 1\end{matrix} ]$$

in general

SftFPn={F(n+1,p)−F(n,p)}−{F(n+1,p−1)−F(n,p−1)}
wheren=1 to 32

4. The sign value of SftFPₙ determines the value of the bit. More specifically,

$$for n = 1 … 32 , {bit}_{n} = \{ \begin{matrix}0 , & if {SftFP}_{n} < 0 \\ 1 , & if {SftFP}_{n} \geq 0\end{matrix}$$

Tests have been performed to analyze the performance of Differential Pie Block Luminance Algorithm without rotation compensation (DPBLA1) with respect to the Centrally Oriented Differential Block Luminance Algorithm (CODBLA). In terms of equal scaling in both directions and horizontal scaling, the pie algorithm performs better. However, it is vulnerable to rotation, vertical scaling and upward shift. The vulnerability to a large amount of rotation can be understood because rotation causes sectors to change in spatial domain and hence each of the sub-fingerprint bits gets affected.

In order to make the DPBLA algorithm resilient to rotation, a further modification can be made; a compensation factor is used in the algorithm. The means of a particular region now also have partial sums of the means of adjacent regions. This helps in increasing robustness against rotation while increasing the standard deviation of the inter-class BER distribution by a little amount. The algorithm also offers improved robustness towards vertical scaling. Hence, the version of the pie-block algorithm with rotation compensation provides significant improvement in finding a close match between fingerprints of original and transformed signals.

Some conclusions that can be drawn from analysis are as follows. The pie differential block luminance algorithm with rotation compensation performs better than centrally-oriented differential block luminance algorithm, in most cases. The inter and intra class BER distribution shows that it serves as a better classification tool than the centrally oriented differential block luminance algorithm. For applications where there is less likelihood of video being modified (like broadcast monitoring on television, selective recording and commercials' filtering), this algorithm can perform much better than the ones discussed before. However, it is more vulnerable to rotation. This is because even small amount of rotation changes the fingerprints significantly. These changes might be aggravated because of other omnipresent transforms like compression and changes in brightness levels etc.

Another algorithm used in embodiments of the invention will now be described. It shall be referred to as the Differential Variable Size Block Luminance Algorithm (DVSBLA). As background, we recall that the centrally oriented differential block luminance algorithm was vulnerable to large amounts of rotation and scaling. The pie differential block luminance algorithm with rotation compensation yielded fingerprints that were highly robust against scaling, but were vulnerable towards rotation. In this description of the DVSBLA, we describe how the performance of the centrally-oriented differential block luminance algorithm can be improved against transformations like scaling and shifting by using variable size of the luminance blocks.

In the basic CODBLA described above, the luminance means are extracted from rectangular blocks. These means are representative of that portion of the frame and provide a representative bit after spatio-temporal filtering and thresholding. However, during geometric transformations, the regions that get affected the most are the ones lying on the outskirts of the processed video frame. These regions most often result in weak bits. Hence, if these regions are made larger, the probability of getting weak bits from these regions is reduced substantially.

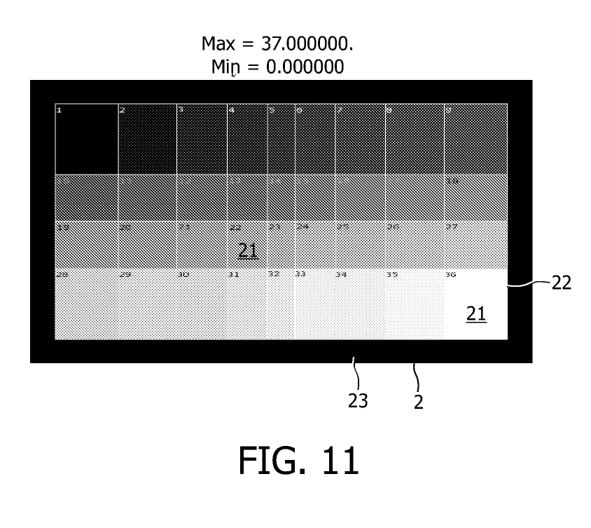

The DVSBLA extraction algorithm is similar to the CODBLA block luminance algorithm. However, in the DVSBLA the regions (blocks 21) are defined as shown in FIG. 11. The sizes of the various blocks in this particular example are given in the following tables 1 and 2, and are represented in terms of percentage of the frame width. The remainders represent the area to be left out on either side.

TABLE 1
The table shows the sizes of various columns in the differential variable size
block luminance algorithm.

| Remainder | Col 1 | Col 2 | Col 3 | Col 4 | Col 5 | Col 6 | Col 7 | Col 8 | Col 9 | Remainder |
|---|---|---|---|---|---|---|---|---|---|---|
| 4% | 12% | 11% | 10% | 9% | 8% | 9% | 10% | 11% | 12% | 4% |

TABLE 2
The table shows the sizes of various rows in the differential variable size
block luminance algorithm.

| Remainder | Row 1 | Row 2 | Row 3 | Row 4 | Remainder |
|---|---|---|---|---|---|
| 5% | 25% | 20% | 20% | 25% | 5% |

The blocks are rectangular just like those used in the centrally oriented differential block luminance algorithm. However, they are now of variable size. The size keeps on decreasing constantly towards the center of the video frame. The geometric increase in the area of the rectangles from the center of the frame helps in providing more coverage for outer regions which are the ones that are most affected during geometrical transformation like cropping, scaling and rotation. In case of shifting, all the regions are affected equally. It may be noticed that the portions in the outskirts of the frame have not been used. This helps in improving reliability by getting fewer weak bits.

The frame rate robustness can be applied at this stage to get the interpolated mean-frames. This procedure has been described in detail above. The sub-fingerprints are then derived from the sequence of mean frames (at the predetermined rate, constructed using interpolation) in the same way as described above in relation to the DBLA and CODBLA.

Analysis of the performance of the DVSBLA, looking at BERs for the wide variety of transformations, has indicated that the BERs have decreased significantly compared to the version with fixed block size. The algorithm has thus become more robust towards all kinds of transformation. The DVSBLA provides more resistance to weaker bits (resulting from border portions) by providing them with a larger area.

Indeed, tests have indicated that, for certain applications, the differential block luminance algorithm with variable size blocks performs better than all other algorithm discussed so far (being equally reliable and more robust than other algorithms). For applications where there is high likelihood of video being modified (like p2p file sharing of cam prints of movies), this algorithm can perform better than the ones discussed before.

Having tested the four major algorithms described above, their relative performance can be summarized as follows:

Robustness of the video fingerprinting system is related to the reliability of the algorithm in correctly identifying a transformed version of a video sequence. The performance of various algorithms in terms of robustness against various transformations is listed in table 3 below.

TABLE 3
The table shows the qualitative performance of the four
algorithms with respect to various geometric transformations
and other processing on video sequences.

| Transformation/ | | | | |
|---|---|---|---|---|
| Processing | DBLA | CODBLA | DPBLA2 | DVSBLA |
| Scaling | Medium | Medium | High | High |
| Horizontal scaling | Medium | Medium | Very High | High |
| Vertical scaling | Medium | Medium | Low | High |
| Rotation | Medium | Medium | Very Low | Medium |
| Upward shift | Medium | Medium | Low | Medium |
| Downward shift | High | Very High | Low | Very High |
| CIF (Common | Medium | Medium | Low | High |
| Interchange Format) | | | | |
| QCIF (Quarter Common | Medium | Medium | Low | High |
| Interchange Format) | | | | |
| SIF (Standard Common | Medium | Medium | Low | High |
| Interchange Format) | | | | |
| Median Filtering (+/−) | Medium | Medium | Medium | Medium |
| Brightness (+/−) | Medium | Medium | Medium | Medium |
| Contrast (+/−) | Medium | Medium | Medium | Medium |
| Compression | Medium | Medium | Medium | Medium |
| Change in frame rate | Very High | Very High | Very High | Very High |

It may be noted that the differential variable size block luminance algorithm (DVSBLA) performs particularly well in terms of robustness. Hence, a fingerprinting system using DVSBLA shall be highly robust against various transformations. However, it will be appreciated that each of the four algorithms in the table (which all incorporate frame rate robustness by extracting sub-fingerprints at the predetermined rate) provides improved robustness over prior art techniques for at least some of the various types of transformation.

The reliability of a video fingerprinting system is related to the false acceptance rate of the system. In order to find the false acceptance rate of various algorithms, their inter-class BER distribution was studied. It was noticed that the distribution closely followed the normal distribution. Hence, assuming the distribution to be normal, standard deviation and percentage of outliers were computed. The standard deviation thus computed gave an idea of the theoretical false acceptance rate of the system. These parameters are shown in table 4, below, for the 4 algorithms.

TABLE 4
The tables shows the parameters obtained from the inter-class
BER distribution for the four algorithms

| ParameterS FOR Inter-Class BER Distribution | DBLA | CODBLA | DPBLA2 | DVSBLA |
|---|---|---|---|---|
| Standard Deviation | 0.01135 | 0.007632 | 0.006626 | 0.0075 |
| False Acceptance Rate | 2.4 × 10⁻²⁰ | 1.2 × 10⁻²⁰ | 1 × 10⁻²⁰ | 1.1 × 10⁻²⁰ |
| Percentage of Outliers <0.35 | 0.006 | 0.002 | 0 | 0 |

It may be noted that the differential pie block luminance algorithm with rotation compensation (DPBLA2) has very good figures. However, differential variable size block luminance algorithm (DVSBLA) is close and can outperform DPBLA2 in certain applications due to its high robustness. Hence, a fingerprint system based on DVSBLA shall have a very low false acceptance rate.

Fingerprint size for all the algorithms is constant at 880 bps. Hence for storing fingerprints corresponding to 5000 hours of video, 3960 MB of storage is needed. However, for various applications, fingerprints corresponding to different amount of video needs to be stored in the database. The following table 5 illustrates a typical storage scenario for various applications discussed above.

TABLE 5
The table shows the approximate storage requirements for
fingerprints in various applications discussed above.

| Application | Storage Requirements |
|---|---|
| Peer-to-Peer Video Filtering | 2000 MB corresponding to 2500 hrs of |
| | video |
| Automatic Video | 1600 MB corresponding to 1000 movies |
| Library Organization | each of approximately 2 hrs duration |
| Broadcast Monitoring | 20 MB corresponding to a day's video |
| Television commercial blocking | 10-20 MB |
| and Selective Recording | |
| Detecting Tampered Video | No storage is needed |

In practice, these storage requirements can be handled very well by the search algorithm described above. Hence, the storage requirements of video fingerprinting systems embodying the invention are practical.

With regard to granularity, the results show that a video fingerprinting system embodying the invention can reliably identify video from a sequence of approximately 5 s duration.

Search speed for a database consisting 24 hrs. of video has been estimated to be in the order of 100 ms.

From the above description it will be appreciated that certain video fingerprinting systems embodying the invention consist of a fingerprint extraction algorithm module and a search module to search for such a fingerprint in a fingerprint database. In certain embodiments of the invention, sub-fingerprints are extracted at a constant frequency on a frame-by-frame basis (irrespective of the frame rate of video source). These sub-fingerprints in certain embodiments are obtained from energy differences along both the time and the space axis. Investigations reveal that the sequence of such sub-fingerprints contains enough information to uniquely identify a video sequence.

In certain embodiments, the search module uses a search strategy for “matching” video fingerprints based on matching methods as described in WO 02/065782, for example. This search strategy does not use naïve brute force search approach because it is impossible to produce results in real-time by doing so due to huge amount of fingerprints in the database. Also, exact bit-copy of the fingerprints may not be given as input to the search module as the input video query might have undergone several image or video transformations (intentionally or unintentionally). Therefore, the search module uses the strength of bits in the fingerprint (computed during fingerprint extraction) to estimate their respective reliability and toggles them accordingly to get a fair (not exact) match.

Algorithms with better performance have been designed, investigated and tested on a large scale. Video fingerprinting systems embodying the invention have been tested and found to be highly reliable, needing just 5 s of video in certain cases to identify the clip correctly. The storage requirement for fingerprints corresponding to 5000 hours of video in certain examples has been approximately 4 GB. Search modules in certain systems have been found to work well enough to produce results in real-time (in the order of ms). Fingerprinting system embodying the invention have also been found to be highly scalable, deployable on Windows, Linux and other UNIX like platforms. Certain video fingerprinting systems embodying the invention have also been optimized for performance by using MMX instructions to exploit the inherent parallelism in the algorithms they use.

Certain embodiments, by deriving video fingerprints from only a central portion of each frame, provide the advantage of delivering fingerprints that are more robust to various transformations.

Similarly, certain embodiments, by deriving video fingerprints from frames divided into non-rectangular blocks, provide the advantage of delivering fingerprints that are more robust to various transformations.

Also, certain embodiments, by deriving video fingerprints from frames divided into differently sized blocks, provide the advantage of delivering fingerprints that are more robust to various transformations.

In summary, the present invention provides novel techniques for generating more robust fingerprints (1) of video signals (2). Certain embodiments of the invention derive video fingerprints only from blocks (21) in a central portion (22) of each frame (20), ignoring a remaining outer portion (23), the resultant fingerprints (1) being more robust with respect to transformations comprising cropping or shifts. Other embodiments divide each frame (or a central portion of it) into non-rectangular blocks, such as pie-shaped or annular blocks, and generate fingerprints from these blocks. The shape of the blocks can be selected to provide robustness against particular transformations. Pie blocks provide robustness to scaling, and annular blocks provide robustness to rotations, for example. Other embodiments use blocks of different sizes, so that different portions of the frame may be given different weighting in the fingerprint.

It will be appreciated that throughout the present specification, including the claims, the words “comprising” and “comprises” are to be interpreted in the sense that they do not exclude other elements or steps. Also, it will be appreciated that “a” or “an” do not exclude a plurality, and that a single processor or other unit may fulfill the functions of several units, functional blocks or stages as recited in the description or claims. It will also be appreciated that reference signs in the claims shall not be construed as limiting the scope of the claims.

1. A method of generating a fingerprint (1) indicative of a content of a video signal (2) comprising a sequence of data frames (20), the method comprising the steps of:
dividing only a central portion (22) of each frame into a plurality of blocks (21), and leaving a remaining portion (23) of each frame undivided into blocks, the remaining portion being outside the central portion, wherein said central portion surrounds a middle portion of the frame and the middle portion is left undivided;
extracting a feature of the data in each block; and
computing a fingerprint (1) from said extracted features.

2. The method in accordance with claim 1, wherein the remaining portion surrounds the central portion.

3. (canceled)

4. The method in accordance with claim 1, wherein said plurality of blocks (21) comprises blocks having a plurality of different sizes.

5. (canceled)

6. The method in accordance with claim 4, wherein the size of said blocks increases in at least one direction moving outwards from a center of the frame.

7. The method in accordance with claim 1, wherein said plurality of blocks (21) comprises a plurality of non-rectangular blocks.

8. The method in accordance with claim 7, wherein said plurality of non-rectangular blocks comprises a plurality of generally sectorial blocks, each said generally sectorial block being bounded by a respective pair of radii (210) from a center of the frame.

9. The method in accordance with claim 7, wherein said plurality of non-rectangular blocks comprises a plurality of generally annular concentric blocks.

10. A method of generating a fingerprint (1) indicative of a content of a video signal (2) comprising a sequence of data frames (20), the method comprising:
dividing each frame into a plurality of rectangular blocks (21) having a plurality of different sizes, wherein a size of a rectangular block increases in at least one direction moving outwards from a center of the frame;
extracting a feature of the data in each block; and
computing a fingerprint (1) from said extracted features.

11. (canceled)

12. (canceled)

13. A method of generating a fingerprint (1) indicative of a content of a video signal (2) comprising a sequence of data frames (20), the method comprising the steps of:
dividing each frame into a plurality of non-rectangular blocks, wherein a middle portion is left undivided;
extracting a feature of the data in each block; and
computing a fingerprint (1) from said extracted features.

14. A method in accordance with claim 13, wherein said plurality of non-rectangular blocks comprises a plurality of generally sectorial blocks, each said generally sectorial block being bounded by a respective pair of radii (210) from a center of the frame.

15. A method in accordance with claim 13, wherein said plurality of non-rectangular blocks comprises a plurality of generally annular concentric blocks.

16. (canceled)

17. A method of generating a fingerprint (1) indicative of a content of a video signal (2) comprising a sequence of data frames, each data frame comprising a plurality of blocks (21), and each block corresponding to a respective region of a video image, the method comprising the steps of:
selecting only a subset of the plurality of blocks for each frame, the selected subset corresponding to a central portion (22) of the video image, wherein said central portion surrounds a middle portion of the video image and the selected subset contains no blocks corresponding to the middle portion;
extracting a feature of the data in each block of the selected subset; and
computing a fingerprint (1) from said extracted features.

18. A method in accordance with claim 17, wherein the central portion (22) is surrounded by an outer portion (23).

20. (canceled)

21. (canceled)

22. A computer program, embedded on a computer readable medium, enabling the carrying out of a method in accordance with claim 1.

23. (canceled)

24. (canceled)
